(19) United States
(12) Patent Application Publication
(10) Pub. No.: US 2005/0246224 A1
(43) Pub. Date: Nov. 3, 2005

(54) Method for minimizing loss or delayed delivery of commercially transported articles

(75) Inventors: Steven Michael McKanna, Lewisville, TX (US); Alex Schemionek, Chicago, IL (US); David J. Tumminaro, Roselle, IL (US); Charles R. Steneck, Dundee, IL (US); Arianne R. Padre, Lombard, IL (US); Barbara N. Tatic, Chicago, IL (US); Kurt Etterer, Chicago, IL (US); Andrew J. Uram, Chicago, IL (US)

Correspondence Address: Winstead Sechrest & Minick P.C., P.O. Box 50784, Dallas, TX, 75201, US

(73) Assignee: American Airlines, Inc., Dallas, TX (US)

(21) Appl. No.: 10/836,466

(22) Filed: Apr. 30, 2004

(51) Int. Cl. G06F 17/60

(52) U.S. Cl. 705/13; 705/1

(57) ABSTRACT

The present invention discloses a computer-based method for minimizing loss or delayed delivery of commercially transported shipments by providing a first database containing transport/operational related data, (a.k.a. “operational data” and “transportation data”); providing a second database containing scanned shipment article identification data; providing third software which accesses a composite database containing integrated information records derived from and originally stored within transport and scanned shipment article databases; interrogating the composite database in response to a user input requirement; formatting said integrated records in response to a user input requirement, and communicating said formatted information to said user via a screen image display (GUI). The invention's process determines data required to satisfy user input requirements, identifies and compiles the information, then presents the information via screen image (GUI) utilizing real-time information retrieved from transportation and shipment article databases.

### REFERENCE TO PENDING APPLICATIONS

This application is not related to any pending applications.

### REFERENCE TO MICROFICHE APPENDIX

This application is not referenced in any microfiche appendix.

### BACKGROUND OF THE INVENTION

The automated scanning and identification of baggage and other commercially transported articles is known. The establishment of a transportation database containing among other record elements, estimated time of departure and arrivals, destination cities and vehicle specific identification information, (e.g. aircraft, vehicle, ship, flight, route number, itinerary) is also known. What is not known is the retrieval and combining of real-time database record elements associated with automated parcel scanning and transportation databases, in satisfaction of a user inquiry via web site enabled software having first considered variable transportation vehicle/parcel shipment parameters.

Consequently it is an object of the present invention to enhance the art by fully utilizing scanning data generated by automated parcel shipment systems (herein referred synonymously and interchangeably as passive baggage scanning systems) to allow a pro-active response to potential baggage/shipment loss or mis-handlings. Throughout the disclosure of the present invention the terms “baggage”, “bags”, “parcel”, “shipment” and “shipment article” are used interchangeably and synonymously. Though for ease of comprehension and clarity the present invention is disclosed in the context of commercial airline baggage systems it will be readily apparent to those skilled in the art that easily envisioned alternative uses of the methodology may be applied to a variety of industries, such as parcel shipment accommodated via land and water bound transportation vehicles.

Another object of the instant invention to utilize real-time information appended to a transportation database and integrate such information with real-time data stored upon a shipment article database once generated via an automated baggage scanning system.

It is a further object of the instant invention to instantaneously provide location information for a parcel once the parcel has entered the scanning system.

Yet another object of the instant invention is to determine delay in processing during parcel routing and delivery by the baggage system.

Another object of the invention is to immediately identify and locate those articles that are entered into an automated scanning system in violation of a minimal routing time standard.

An additional object of the instant invention is to identify problem locations, such as, mis-timed parcel ejection (delivery) points.

A further object of the invention is to identify mis-handled articles at their point of origin.

Another object of the invention is to parse automated scanning generated information and integrate it with real-time operational data to facilitate the on-time transfer of interconnecting and originating baggage.

An object of the instant invention is to present integrated baggage data to supervisory personnel and others via web site presentation.

Another object is to fully utilize automated parcel scanning data that is generated by legacy systems and not utilized in the contemporary art.

Yet another object of the instant invention is to pro-actively utilize integrated shipment article and transportation information relating to articles to respond to potential baggage mis-handlings.

A further object of the instant invention is to pro-actively respond to baggage mis-handlings utilizing parcel identification point of entry passive scanning devices as opposed to hand scanning devices that are less reliable and reduce productivity of employees.

Another object is to identify mis-handled articles at the time of service failure as opposed to customer reported mis-handlings.

Another object is to provide automated web based information to subsequent transfer station (a.k.a. “down line station”) of mis-handled articles.

Yet another object of the instant invention is to identify productivity of parcel shipment employees/staffing encoding locations.

A further object is to alert personnel of baggage staged at oversized baggage locations.

Another object of the instant invention is to provide enhanced and timely baggage handling absent necessity for additional head count or use of handheld scanners.

### SUMMARY OF THE INVENTION

The present invention discloses a computer-based method for minimizing the potential loss or delayed delivery of commercially transported shipments comprising the steps of providing a first database containing transport related data, (a.k.a. “operational data” and “transportation data” such as but not limited to operational data generated via real-time legacy systems, for example the American Airlines Flight Operating System (FOS)); providing a second database containing scanned shipment article identification data; providing third software which accesses a composite database containing integrated information records derived from and originally stored within transport and scanned shipment article databases; interrogating the composite database in response to a user input requirement; formatting said integrated records in response to a user input requirement, and communicating said formatted information to said user via a screen image display (GUI).

### BRIEF DESCRIPTION OF THE DRAWINGS

FIG. 1 is a system schematic illustrating hardware and software components associated with one embodiment of the instant invention.

FIG. 2 is a logic flow diagram depicting a non-limiting step sequence of the invention's computerized methodology.

FIG. 3 is a non-limiting example of a graphical user interface (GUI) used to initiate process step execution of the methodology of the instant invention. FIG. 3 speaks specifically to an example of initiating parameter navigation tools (a) and transport articles at risk for mis-connecting with a departing parcel transport vehicle (b).

FIG. 4 illustrates a non-limiting example of a screen image user response denoting transport articles missing connection to a departed transport vehicle.

FIG. 5 illustrates a non-limiting screen image user response of transportation articles which encountered delay or nearly missed connecting to an intermediate or originating city transport vehicle departure.

FIG. 6 illustrates a non-limiting screen image user response of transportation articles that have intentionally or inadvertently been introduced into the system through the instant invention's scanning and tracking mechanism, as opposed to being placed upon an available scheduled transport vehicle for shipment.

FIG. 7 illustrates a non-limiting screen image user response example denoting change(s) in departing location of scheduled article transport vehicles.

FIG. 8 illustrates a non-limiting screen image response denoting those instances where a customer scheduled to accompany a transport article shipment has subsequently modified his or her travel arrangements from that originally scheduled.

### DETAILED DESCRIPTION OF THE PREFERRED EMBODIMENTS

While the making and using of various embodiments of the present invention are discussed below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

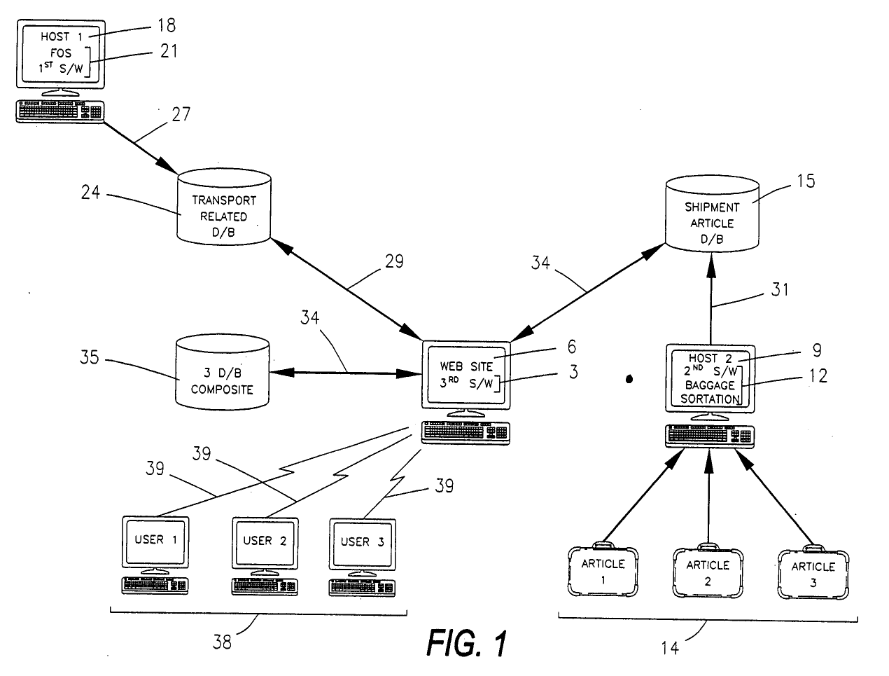

FIG. 1 is a system schematic showing hardware and software components associated with the preferred embodiment of the instant invention. Turning now to FIG. 1.

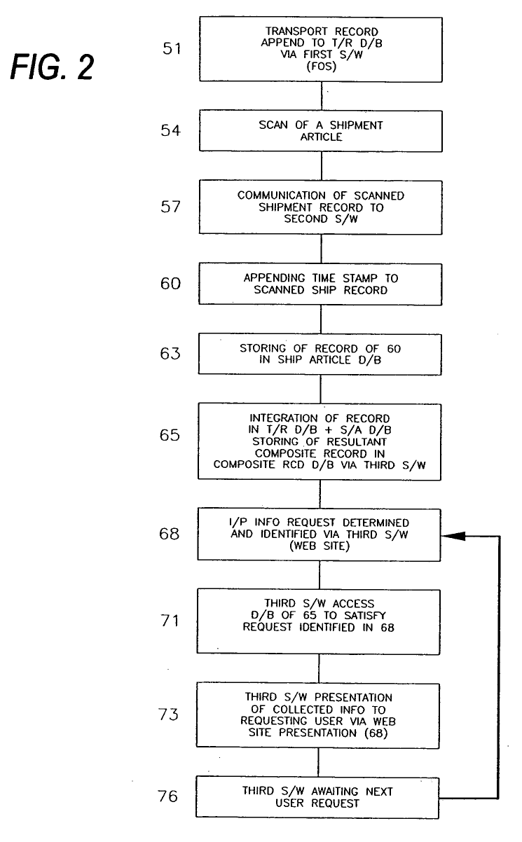

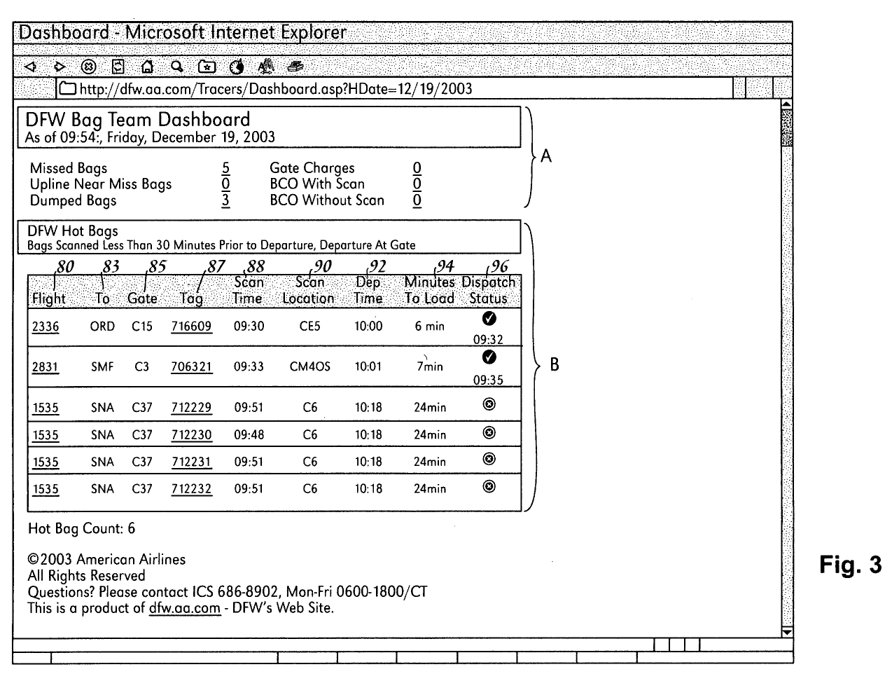

In FIG. 1 it is shown where the present invention is comprised of web enabled software 3 executing under the dispatching control of server central processing unit's 6 control program. As used throughout this application the term “web enabled software” is used interchangeably and synonymously with third software. A plurality of users 38 are connected to the server central processing unit 6 by utilizing a hard wired, wireless or telecommunication network means 39 well known to those skilled in the art. Non-limiting examples of such networks would include but not be limited to such as a local area networks (LAN), wide area networks (WAN), metropolitan area networks (MAN), campus-wide networks (CAN), Intranet and Internet. A second host central processing unit 9 executes under its dispatching control, second software 12. Second software 12 will be recognized by those skilled in the art as any one of a number of automated parcel scanning systems (a.k.a. “Baggage Sortation Systems”) which automatically identify and route one or more articles to be transported 14 to a departing transport location and can be modified to interface with third party proprietary software. A non-limiting example of such proprietary software would be the proprietary software used throughout the American Airlines passenger service system, commonly referred to and known as “BAASIC”. The second software 12 identifies and scans shipped article 14, and communicates uniquely identifiable information as a database record to be stored within shipment article database 15. As used herein the term “shipment article database” is referred to synonymously and interchangeably with “transport article database” and “BPM database”. The database record communication to database 15 may occur over any computer compatible network communication means. As will be discussed more thoroughly, third software 3 also accesses shipment article database 15 with such access provided by either locally, or remotely connected communications link(s) 34. Transportation information (a.k.a. “operational data” and “transport related data”), such as but not limited to information indicating a flight number, vehicle number, ship name, aircraft number and location, departure location, etc. is processed in a real-time mode via first software 21 executing under the operational dispatching control of central processor 18's central program. As used herein the term “real-time” indicates a software capability means which automatically recognizes a change in status of one or more record elements and automatically updates those database resources pertaining to such data elements. The automated updating of these subject data elements provides for “up-to-minute” information upon which management and/or customer relation decisions may be made. By way of example and as referenced throughout the disclosure of the present invention, one example of a non-limiting third software system would be the Flight Operating System (a.k.a. FOS) utilized in conjunction with the American Airlines® Sabre® system. Predetermined transport related data records are generated and processed by first software 21 with such records stored upon transport record database 24 via a communications link 27 in a “real-time” mode. The transport database 24 is further communicably attached to third software 3 by communications link 29. Conceptually overviewed, the invention is practiced by one or more users 38 inquiring and requiring of third software 3, information related to shipment articles 14 first stored on databases 15 and 24. The computerized methodology of the present invention associates data elements stored within the shipment article database 15 and transport related database 24 and combines such integrated information into a composite record stored upon a composite database 35. Integration proceeds according to schema which correlates scanned article identification, such as but not limited to a bag tag to uniquely identifiable customer identifiable record on the transport/operational database. Such passenger identifiable records are commonly referred to within the airline industry as portions of a Passenger Name Record (PNR) which further includes customer specific information and scheduled itinerary including but not limited to flight number and/or destination city. This “combined/integrated” information represents a real-time record or records of articles/baggage to be shipped upon a transport vehicle irrespective of vehicle type as well as information containing relevant customer data, departure times, transport vehicle identification, location and other data. Such integrated information will be discussed in detail in association with FIGS. 3 through 8 wherein “originating data source” indicates database (either 15 or 24) from which originating data elements are retrieved, interrogated and combined (integrated) for subsequent presentation and storage upon the composite database 35. Third software 3 recognizes a user input request via a web site enable software graphical user interface (GUI), determines the type of information record or records required to satisfy the request, accesses database 35 to retrieve such records, then returns records retrieved in satisfaction of the users request back to the user over communications link 39 in the form of a responding graphic user interface screen image. Such user interfaces and the information contained therein will be presented in detail in association with discussion of FIGS. 3 through 8. To reiterate, composite records stored on database 35 are those records which have been retrieved and integrated by third software 3 from shipment article database 15 and transport record database 24. FIG. 2 illustrates the logic flow sequence when processing a user inquiry with respect to transport record and/or shipment article database information. Turning now to FIG. 2.

In FIG. 2 a transport related/operational record is appended to the transport record database via first software 51. Non-limiting examples of transport records that are appended and processed according to first software are immediately provided in Table 1 below:

TABLE 1
Data Record Type/Content:

Date
Origin City
Flight
Origin Date
Actual Departure City
Actual Arrival City
Leg Status
Departure Status
Arrival Status
Scheduled Departure Date
Scheduled Departure Time
Scheduled Arrival Date
Scheduled Arrival Time
Actual Departure Date
Actual Departure Time
Actual Arrival Date
Actual Arrival Time
Airline
Scheduled Equipment Type
Actual Equipment Type
First Class Seats
Actual Tail (Ship) Number
Business Class Seats
Coach Class Seats
Total Seats
Ground Objective
Taxi Out Time
Taxi In Time
Departure Gate
Arrival Gate
Zone
Sub Zone
Passenger Services CSM Employee Number
Passenger Services Manager Employee Number
Ramp Services CSM Employee Number
Ramp Services Manager Employee Number
Tower CSM Employee Number
Tower Manager Employee Number
4th Department CSM Employee Number
4th Department Manager Employee Number
5th Department CSM Employee Number
5th Department Manager Employee Number
6th Department CSM Employee Number
6th Department Manager Employee Number
Departure Terminal
Arrival Terminal
Baggage Claim Number
AM/PM Indicator
Delay Minutes
Complex Number
Scheduled First Arrival City
Scheduled Second Arrival City (“next stop” after 1st arrival city)
Scheduled Third Arrival City (“next stop” after 2nd arrival city)
Next Flight Number (turning flight number)
Next Flight Date (turning flight date)
Previous Flight Number (turned flight number)
Previous Flight Date (turned flight date)
Greenwich Mean Time (GMT) Adjustment For Departure City
Greenwich Mean Time (GMT) Adjustment For Arrival City
Total Customers
Thru Customers
Connecting Customers
First Class Local Count
First Class Child Count
First Class Excess Weight
First Class Thru Count
First Class Thru Child Count
First Class Thru Excess Weight
Business Class Local Count
Business Class Child Count
Business Class Excess Weight
Business Class Thru Count
Business Class Thru Child Count
Business Class Thru Excess Weight
Coach Class Local Count
Coach Class Child Count
Coach Class Excess Weight
Coach Class Thru Count
Coach Class Thru Child Count
Coach Class Thru Excess Weight
Local Cockpit Jumpseat Rider Count
Thru Cockpit Jumpseat Rider Count
Local Cabin Jumpseat Rider Count
Thru Cabin Jumpseat Rider Count
Kickoff Flight Indicator
Time Record Last Updated

Prior to, concurrent with, or subsequent to transport record appendage to the transport record database, an automated scan of a shipment article takes place 54 with identifying information related to the scanned article communicated to the second software 57. Automated scanning of shipment articles takes place in concert with automated baggage sortation scanning systems well known to those skilled in the art, with proprietary software allowing for a time stamp to be appended to the record generated by the automated scanning system denoting time the shipment article had been introduced to the process of the instant invention 60 via scan execution in 54. It is contemplated by the instant invention that a variety of scanning processes may be employed in its practice. As an example contemporary art baggage sortation systems rely heavily upon bar code scanning technology. It would be obvious to those skilled in the art to employ an alternative form of scanning recognition technology such as a RF (radio frequency) chip or chips imbedded within tags to denote and identify the presence of a transport article, without departing from the intent or practice of the instant invention. The scanned record (with appended time stamp) is then stored upon a shipment article database in step 63. The computer resident methodology of the instant invention then associates and integrates shipment article information stored in the shipment article database (15, FIG. 1) with transport related records stored within Operational database (24, FIG. 1) to create a composite record which associates article shipment information with relevant transport vehicle information. This integrated information set is then stored within a composite record database 65 (35, FIG. 1) by the third software. Though not individually required, through exhaustive testing it has been found that the most effective practice of the instant invention is realized via the real-time or instantaneous determining and storing of relevant database records to shipment article database 15, transportation record database 24 and composite record database 35. Users in FIG. 138 are permitted to make one or more input inquiries relating to information stored on the composite database 35, or alternatively, individually appended records maintained on transaction database 24 (FIG. 1) or shipment article database 15 (FIG. 1).

Returning to FIG. 2, the software of the instant invention (3, FIG. 1) next determines the type of information required to satisfy user request 68 and accesses the composite database to retrieve records 71 to satisfy the user request. Once having garnered all information necessary to satisfy the user request of 68, the third software presents the collected information to the requesting user via a web site graphic user interface screen presentation in 73. The software then returns to a polling or “recognition mode” 76 where it awaits the next user input information request and processes subsequent user requests as previously taught by first identifying the type of information required, retrieving the information and then presenting it via a web site presentation to the requesting user. This process repeats in an iterative manner until all such user requests are satisfied whereupon the instant invention sits in an idle state awaiting further input inquiry.

As indicated earlier, it will be easily envisioned by those skilled in the art that process steps of the present invention can be applied to any number of sequences wherein articles are to be transported by one or more vehicle types. For purposes of clarity, example and non-limiting disclosure, the functionality of the instant invention is best understood by relating it to a specific practicing model. The instant application will so proceed in this regard by disclosing its practice invention in association with airline passenger baggage scanning and tracking systems.

As articles travel the length of the bag belt in any bag room with passive scan points, scan data is recognized and communicated to the invention's second software (synonymously referred to herein as “BAASIC” or “Baggage Sortation Systems”). A scan record is typically though not limitedly sent to BAASIC each and every time a bag is scanned. Should a bag re-circulate in the system, and pass by a passive scan point a second, third or other occasion, an additional scan record is created for each scanned occasion. The scanned record is processed via the second software and along with a time stamp inserts the message (referred to synonymously herein as “record”) into the system's shipment article database (BPM) 15 (FIG. 1). The message, typically though is not limitedly, is stored in the following International Air Transport Association (“IATA”) format in Table 2:

TABLE 2
BPM .V/1TJFK. J/S/BAASIC/UM1/18DEC/0201L/JFK
.F/AA0879/18DEC/MIA/Y
.I/AA0141/17DEC/LHR/Y .O/AA5165/18DEC/GGT/Y
.N/4001405153001
.P/SMITH/GODFR ENDBPM

Record elements in Table 2 proceed according to the following identification scheme, where:
BPM V/IT=BPM header; constant; section mandatory
JFK=Message City; variable
.J/S/BAASIC/=Scan data header for BAASIC system; constant
UM1/=Scan location; variable
18DEC/=Scan Date; variable
0201L/=Scan time (L indicates local time); variable
JFK=Scan location city; variable
.F/=Outbound flight data header; constant; section mandatory
AA0879/=Outbound carrier and flight number; variable
18DEC/=Outbound flight date; variable
MIA/=Outbound City; variable
Y=Placeholder; constant
.I/=Inbound flight data header; constant; section optional
AA0141/=Inbound carrier and light number; variable
17DEC/=Inbound flight date; variable
LHR/=Upline city of inbound flight; variable
Y=Placeholder; constant
.O/=Onward flight data header; constant; section optional
AA5165/=Onward flight number (at downline city); variable
18DEC/=Onward date (at downline city); variable
GGT/=Onward destination (at downline city); variable
Y=Placeholder; constant
.N/=Bag tag information header; constant
4001405153001=Bag tag number; variable
.P/=Passenger Information Header; constant
SMITH/=Passenger Last Name; variable
GODFR=Passenger First Name; variable
ENDBPM=End of BPM; constant

The BPM database continues to build as messages are stored within it. At a predefined interval, formatted BPM records associated with relevant operational data are forwarded to the composite database 35 via third software 3. As used herein the terms “real-time flight data” are used interchangeably and synonymously with “transportation record database”, “flight database” and/or “FOS records database”. The now formatted BPM records are joined with existing real-time operational flight data for presentation on a web page by third software in response to a user inquiry.

Specific structured query language “queries” return different views of the BPM/Flight Data depending on a user's input requirement and separate web pages are created to present the detail of this data. Additionally a “Dashboard” or GUI is provided and taught by the instant invention to initiate process step execution and control.

FIG. 3 is a non-limiting example of a graphical user interface used to initiate process step execution of the methodology of the instant invention. FIG. 3 speaks specifically to an example of initiating parameter navigation tools and transport articles at risk for mis-connecting with a scheduled transport vehicle for shipment. A description of a Dashboard summary page is illustrated as well as related detail pages is present and discussed in association with FIG. 3. Turning now to FIG. 3.

FIG. 3 illustrates a graphic user interface which is referred to synonymously and interchangeably throughout this disclosure as “dashboard” or “bag team dashboard”. A description of the information presented in the dashboard graphic user interface follows with the database source of the information indicated as well as the sponsoring or storing software (a.k.a. first software, second software, third software).

There are two primary sections to the Dashboard illustrated in FIG. 3.

Section A is a summary of the major points of interest to those users whose attention is concentrated measurements relating to parcel handling (also known as “Bag Team”). Each of these measurements are explained separately in FIGS. 3 through 8.

Section B of FIG. 3 illustrates those articles that are currently traveling through the baggage system and are considered at risk of being mishandled (“Hot”).

As used herein, the definition of a Hot Bag is a bag that has been scanned within 30 minutes of departure time and the actual departure time of the aircraft is also within 30 minutes. The “30 Minute Rule” is alterable and may be configured by the user to specify any other time interval.

Dashboard Column Definitions

Flight 80 (Originating Data Source: BPM Database)
Departure flight for which the bag/parcel is destined
To 83 (Originating Data Source: FOS, (a.k.a. first software) Flight Data Database)
Next destination of the bag/parcel
Gate 85 (Originating Data Source: FOS, Flight Data Database)
Departure gate for the flight and bag/parcel
Tag 87 (Originating Data Source: BPM Database)
Short tag number for the bag/parcel.
Scan Time 88 (Originating Data Source: BPM Database)
Time bag/parcel was scanned in the baggage system
Scan Location 90 (Originating Data Source: BPM Database)
Location at which the bag/parcel was scanned
Departure Time 92 (Originating Data Source: FOS, Flight Data Database)
Current departure time of the flight for which the bag/parcel is destined
Minutes To Load 94 (Calculated Number)
A calculation of the difference, in minutes, between the moment the web page is displayed and the actual departure time of the aircraft/transport vehicle.
Dispatch Status 96 (User Input, Dispatch Status Database)
Bag/parcel team members have the opportunity to take action on each Hot Bag/parcel. If dispatched a runner to find the bag/parcel and deliver it to an indicated departure gate, a Bag Team member may click on the Dispatch Status button to indicate someone was dispatched. An optional color “X” icon will then change to a second optional “Check Mark” icon, indicating a dispatched runner.

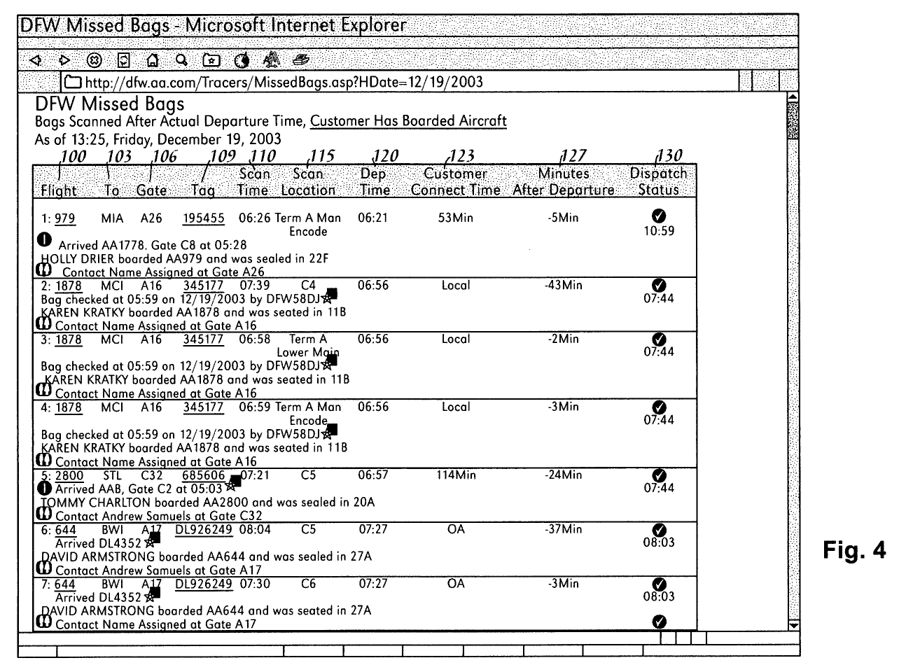

FIG. 4 illustrates a non-limiting example of a screen image user response denoting transport articles missing connection to a departed transport vehicle. The present invention assumes that FIG. 4 information is required as a consequence of a user input requesting missed bag information. As used herein, the term “missed articles” will be readily appreciated by those skilled in the art to include not only passenger baggage but any transport article to be shipped on a plane or transportation vehicle. Turning now to FIG. 4.

In FIG. 4 the instant invention has determined that user has inquired via input request for information relating to missed articles. This inquiry step of the instant invention methodology is indicated as step 68 on FIG. 2. In response thereto, the instant invention retrieves one or more composite records from the composite database 35 and presents collated/formatted information from database 35 to the user. This return to the user is designated in step 73 of FIG. 2. FIG. 4 illustrates according to column definition those databases from which the original information has been retrieved by the invention's third software compiled and stored upon the composite database. In FIG. 4 it is seen where:
Flight 100 (Originating Data Source: BPM Database)
Departure flight for which the bag/parcel is destined
To 103 (Originating Data Source: FOS, Flight Data Database)
Next destination of the bag/parcel
Gate 106 (Originating Data Source: FOS, Flight Data Database)
Departure gate for the flight and bag/parcel
Tag 109 (Originating Data Source: BPM Database)
Short tag number for the bag/parcel.
Scan Time 110 (Originating Data Source: BPM Database)
Time bag/parcel was scanned in the baggage system
Scan Location 115 (Originating Data Source: BPM Database)
Location at which the bag/parcel was scanned
Departure Time 120 (Originating Data Source: FOS, Flight Data Database)
Current departure time of the flight for which the bag/parcel is destined
Customer Connect Time 123 (Calculated Number)
If the customer has connected, the actual number of customer connection minutes (difference between customer's actual arrival and customer's actual departure times) is displayed. If the customer is originating, the word “Local” is displayed.
Minutes To Load 127 (Calculated Number)
A calculation of the difference, in minutes, between the moment the web page is displayed and the actual departure time of the aircraft. Since the definition of a Missed Bag/parcel is one that is scanned after departure time, this on this page this number is always expressed in negative minutes (indicating number of minutes after departure time).
Dispatch Status 130 (User Input, Dispatch Status Database)
Bag/parcel Team members are required to notify the Customer Service Manager (CSM) on duty for the departure that a bag/parcel was missed. The purpose of the notification is for employee follow-up. Once the CSM has been notified, the Bag/parcel Team member will click an indicator here, “Red X” icon to indicate notification, and the icon will then change to a “Green Check Mark”.
Other Information On Missed Bag/parcels Page
There is additional ancillary information found on this page. Included are:
Transfer Bag/parcel Icon—FIG. 3
When present, this icon indicates that the bag/parcel in question is a connecting bag/parcel. The icon is followed by the arriving flight information for the customer and bag/parcel. If no transfer icon exists for a bag/parcel that indicates it is a locally checked bag/parcel.
CSM Name Icon—FIG. 3
This icon is displayed to draw attention to the CSM (Customer Services Manager) name. At the beginning of their shifts CSMs sign into the web and state their work area. This information is then stored in an Employee Assignments database associated with a proprietary software system beyond the scope of the present invention.
Tracer Icon—FIG. 3
This icon indicates that the customer has filed a mishandled bag/parcel tracer at their destination.
Forwarding Information Exists Icon—FIG. 3
When the Station that has mishandled the bag/parcel forwards the bag/parcel to the customer's destination, flight number, etc.

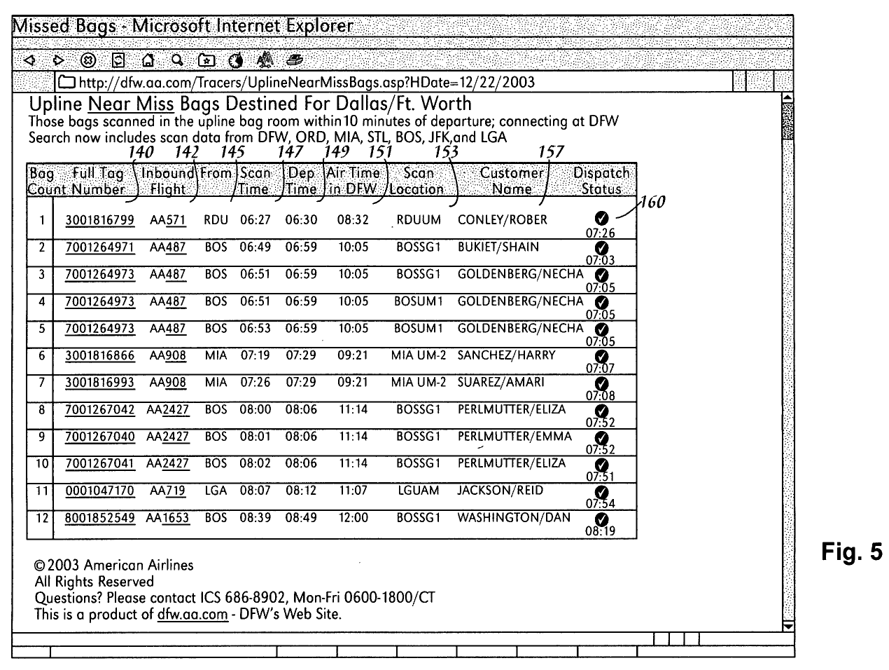

FIG. 5 illustrates a non-limiting screen image user response example denoting of transportation articles which encountered delay or nearly missed connecting to an intermediate or originating city transport vehicle departure. The present invention assumes that FIG. 5 information is required as a consequence of a user requesting information relating to transportation articles which encounter delay or nearly missed connecting to an intermediate or originating city transport vehicle departure. FIG. 5 illustrates according to column definition those databases from which the original information has been retrieved by the invention's third software compiled and stored upon the composite database. In FIG. 5 it is seen where:

Upline Near Miss articles as used herein refer to those articles that are destined to connect through the Station, but where scanned within 10 minutes of the upline departure and thus more likely to not be on-board their departing aircraft (transportation vehicle).
Full Tag Number 140 (Originating Data Source: BPM Database)
Full 10-digit IATA compliant tag number is displayed. Users may click on the tag number for further information about this bag/parcel which is retrieved from Sabre.
Inbound Flight Number 142 (Originating Data Source: BPM Database)
Flight number of the aircraft arriving in the Station
From 145 (Originating Data Source: BPM Database)
Upline city where the bag/parcel was scanned
Scan Time 147 (Originating Data Source: BPM Database)
Scan time of the bag/parcel in the upline city that triggered the alert
Departure Time 149 (Originating Data Source: FOS, Flight Data Database)
Departure time of aircraft in upline city
Arrival Time 151 (Originating Data Source: FOS, Flight Data Database)
Arrival time of the aircraft in the local city
Scan Location 153 (Originating Data Source: BPM Database)
Location bag/parcel was scanned that triggered the alert
Customer Name 157 (Originating Data Source: BPM Database)
Name of the customer attached to the bag/parcel tag
Dispatch Status 160 (User Input, Dispatch Status Database)
Once noted that the bag/parcel was an upline near miss, the Bag/parcel Team member will click on the “Red X” (not noted) which will then change to a “Green Check” (noted).

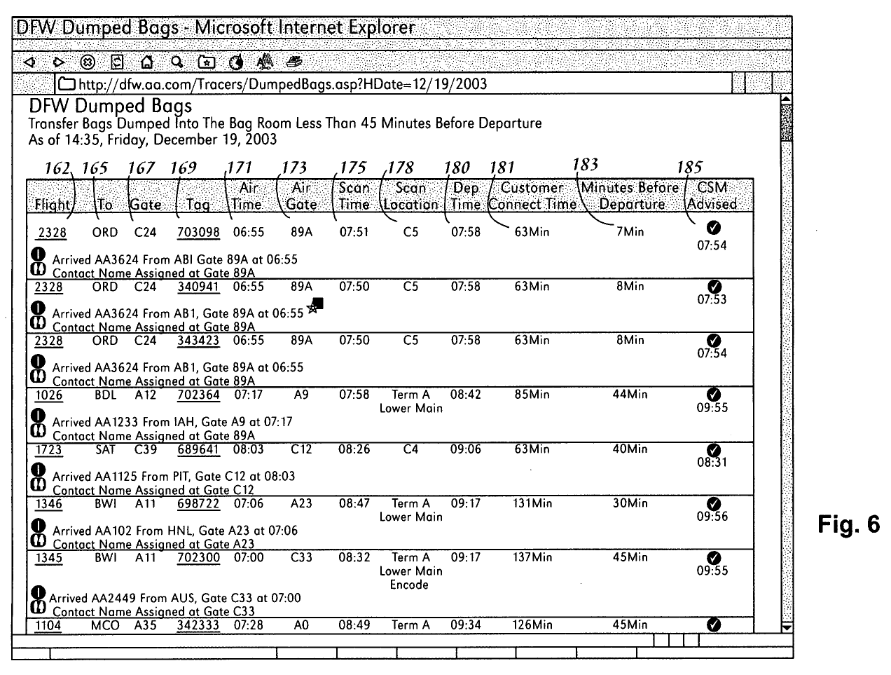

FIG. 6 illustrates a non-limiting screen image user response of transportation articles that have intentionally or inadvertently been introduced into the system through the instant invention's scanning and tracking mechanism, as opposed to being placed upon an available scheduled transport vehicle for shipment. The present invention assumes that FIG. 6 information is required as a consequence of a user input requesting information relating to transportation articles/bags that have intentionally or inadvertently been introduced into the system through the instant invention's tracking mechanism as opposed to being placed upon a scheduled transport vehicle for shipment. FIG. 6 illustrates according to column definition those databases from which the original information has been retrieved by the invention's third software compiled and stored upon the composite database.

Typically articles that connect in a Hub are transferred in a manner known as “tail-to-tail”. These articles do not go into the local bag room for re-delivery to the gate unless the connecting aircraft or other vehicle is not at the gate yet or if there is a long (generally more than 60 minutes) ground time.

The Dumped Bags page is used to identify those articles that were “dumped” into the bag system that should have been transferred directly to the connecting aircraft. In FIG. 6 it is seen where:
Flight 162 (Originating Data Source: BPM Database)
Departure flight for which the bag/parcel is destined
To 165 (Originating Data Source: BPM Database)
Next destination of the bag/parcel
Gate 167 (Originating Data Source: FOS, Flight Data Database)
Departure gate for the flight and bag/parcel
Tag 169 (Originating Data Source: BPM Database)
Short tag number for the bag/parcel.
Arrival Time 171 (Originating Data Source: FOS, Flight Data Database)
By definition Dumped Bag/parcels are connecting bag/parcels, so this is the actual arrival time of the customer's inbound aircraft (the aircraft from which the customer is connecting).
Arrival Gate 173 (Originating Data Source: FOS, Flight Data Database)
The arrival gate of the aircraft
Scan Time 175 (Originating Data Source: BPM Database)
Time bag/parcel was scanned in the baggage system
Scan Location 178 (Originating Data Source: BPM Database)
Location at which the bag/parcel was scanned
Departure Time 180 (Originating Data Source: FOS, Flight Data Database)
Current departure time of the connecting flight for which the customer and bag/parcel are destined
Customer Connect Time 181 (Calculated Number)
The actual number of customer connection minutes (difference between customer's actual arrival and customer's actual departure times) is displayed.
Minutes Before Departure 183 (Calculated Number)
A calculation of the difference, in minutes, between the moment the web page is displayed and the actual departure time of the aircraft. Since the definition of a Missed Bag/parcel is one that is scanned after departure time, this on this page this number is always expressed in negative minutes (indicating number of minutes after departure time).
CSM Advised 185 (User Input, Dispatch Status Database)
Bag/parcel Team members may notify a Customer Service Manager (CSM) or other supervisory personnel on duty for the arrival that a bag/parcel was Dumped. The purpose of the notification is for employee follow-up. Once the CSM has been notified, the Bag/parcel Team member will click the “Red X” icon to indicate notification, and the icon will then change to a “Green Check Mark”.
Other Information On Dumped Bag/parcels Page
There is additional ancillary information found on this page. Included are:
Transfer Bag/parcel Icon—FIG. 3
When present, this icon indicates that the bag/parcel in question is a connecting bag/parcel. The icon is followed by the arriving flight information for the customer and bag/parcel. If no transfer icon exists for a bag/parcel that indicates it is a locally checked bag/parcel.
CSM Name Icon—FIG. 3
This icon is displayed to draw attention to the CSM (Customer Services Manager) name. At the beginning of their shifts CSMs sign into the web and state their work area. This information is then stored in an Employee Assignments database associated with a proprietary software system beyond the scope of the present invention.
Tracer Icon—FIG. 3
This icon indicates that the customer has filed a mishandled bag/parcel tracer at their destination.
Forwarding Information Exists Icon—FIG. 3
When the Station that has mishandled the bag/parcel forwards the bag/parcel to the customer's destination, flight number, etc.

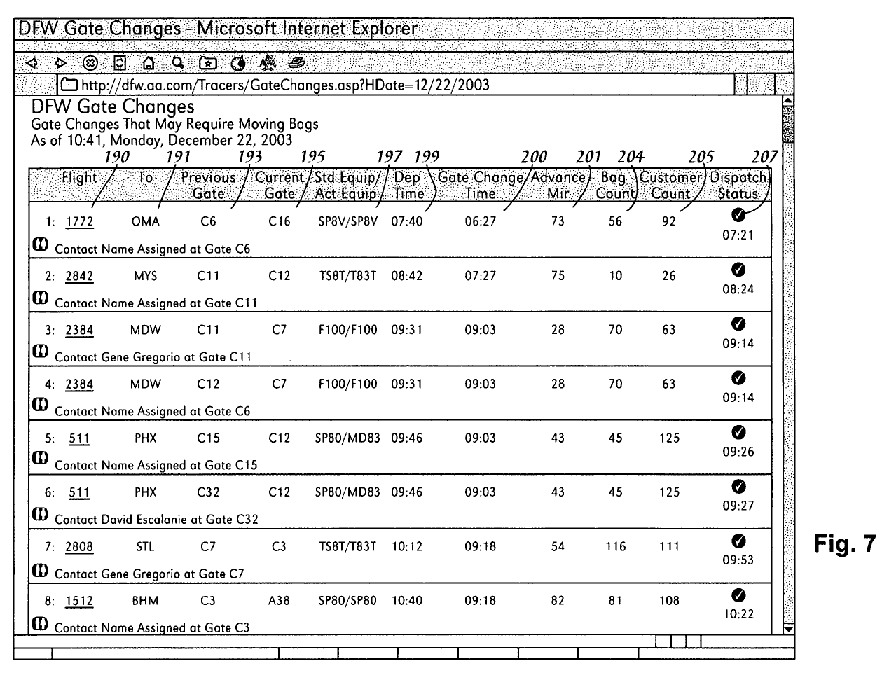

FIG. 7 illustrates a non-limiting screen image user response example denoting change(s) in departing location of scheduled article transport vehicles. The present invention assumes that FIG. 7 information is required as a consequence of a user input requesting information relating to a change of location in a scheduled transport vehicles departure. FIG. 7 illustrates according to column definition those databases from which the original information has been retrieved by the invention's third software compiled and stored upon the composite database. In FIG. 7 it is seen where:

Gate changes are those flights that were previously scheduled at a particular gate and have now been changed to depart from a different gate. This can occur multiple times through the course of an operational day.

Departing articles are generally delivered to the departure gate during the last 30-45 minutes before departure.

This is important to note because if a departure gate is changed, the departing articles that have already been delivered to the departure gate need to be moved to the new departure gate.

The purpose of the Gate Changes page is to alert the Bag Team member that a departure gate has changed within 60 minutes of scheduled departure and the potential exists that departing articles have already been delivered to the departure gate.
Flight 190 (Originating Data Source: FOS, Flight Data Database)
Departure flight number where the gate has changed
To 191 (Originating Data Source: FOS, Flight Data Database)
Destination of the departing flight
Previous Gate 193 (Originating Data Source: FOS, Gate Change Database)
The gate at which the departure was previously scheduled and thus the gate that needs to be checked for departing bag/parcels that may have already been delivered.
Current Gate 195 (Originating Data Source: FOS, Flight Data Database)
The gate at which the departure is currently scheduled and thus the gate to which departing bag/parcels need to be moved.
Scheduled & Actual Equipment 197 (Originating Data Source: FOS, Flight Data Database)
Many times when a departure gate changes the equipment type of the departing aircraft changes. This is especially important when the new equipment type is smaller than the previous equipment.
Departure Time 199 (Originating Data Source: FOS, Flight Data Database)
Scheduled departure time of the flight
Gate Change Time 200 (Originating Data Source: FOS, Gate Change Database)
Time the gate change occurred
Advance Minutes 201 (Calculated Number)
Minutes in advance of the scheduled departure the gate change occurred. Only those gate changes that occur within 90 minutes of departure are displayed.
Bag/parcel Count 204 (Originating Data Source: BPM Database)
Worst cast scenario of the number of bag/parcels that may be found at the previous gate
Customer Count 205 (Originating Data Source: FOS, Gate Change Database)
Ancillary information offered as guidance to the Bag/parcel Team member as bag/parcel counts generally track closely to customer counts.
Dispatch Status 207 (User Input, Dispatch Status Database)
When a gate change occurs within 90 minutes of departure, sometime in the last 30-45 minutes a Bag/parcel Team member will dispatch a runner to ensure that all bag/parcels for the departure have been picked up at the previous gate.
Once the dispatch is made, the Bag/parcel Team member will click on the “Red X” (not dispatched), which will then change to a “Green Check” (dispatched).

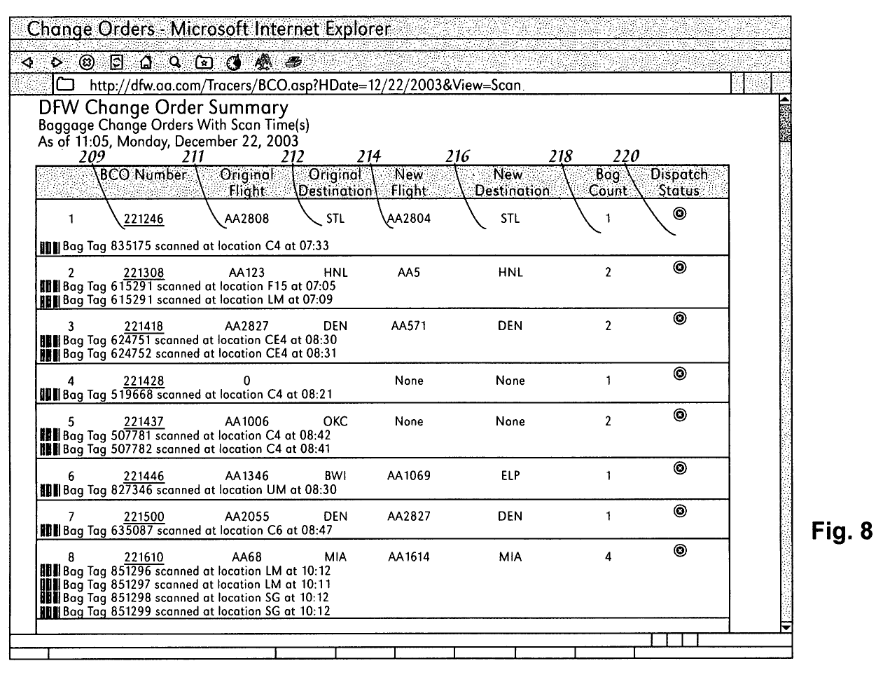

FIG. 8 illustrates a non-limiting screen image response denoting those instances where a customer scheduled to accompany a transport article shipment has subsequently modified his or her travel arrangements from that originally scheduled. The present invention assumes that FIG. 8 information is required as a consequence of a user input requesting information relating to a an instance where a customer is scheduled to accompany a transport vehicles shipment and subsequently has altered his or her transportation itinerary/time/vehicle. Baggage Change Orders (BCO) are used as a tool to communicate with the bag room when a customer changes departing flights. Baggage Change Orders are by sent via Sabre and are automatically printed in the bag room. The BCO is used to describe the customer bag(s), along with bag tag number(s), and old and new routing information. When a BCO is taken by an agent on the concourse, the implicit agreement with the customer is that the bag will travel with them on their new flight. It is now up to the bag room to actually move the bag(s) to the new departure. FIG. 8 illustrates according to column definition those databases from which the original information has been retrieved by the invention's third software compiled and stored upon the composite database. In FIG. 8 it is seen where:
BCO Number 209 (Originating Data Source: DECS, Baggage Change Order Database)
Change order number that is assigned by the Sabre Host and is unique
Original Flight Number 211 (Originating Data Source: DECS, Baggage Change Order Database)
Original flight number of customer and bag/parcel(s)
Original Destination 212 (Originating Data Source: DECS, Baggage Change Order Database)
Original destination of customer and bag/parcel(s)
New Flight Number 214 (Originating Data Source: DECS, Baggage Change Order Database)
Flight number to which customer has changed
New Destination 216 (Originating Data Source: DECS, Baggage Change Order Database)
New destination of customer and bag/parcel(s)
Bag Count 218 (Originating Data Source: DECS, Baggage Change Order Database)
Number of bag/parcels customer has checked
Dispatch Status 220 (User Input, Dispatch Status Database)
When a change order is received by the bag/parcel room a runner is dispatched to find the bag/parcel and switch it to the new flight and destination based on the information found in the baggage change order.
Until a runner is dispatched by the Bag/parcel Team member, a “Red X” or other indicator (not dispatched) is displayed. Once a runner has been dispatched the Bag/parcel Team member will click on the “Red X” and it is then changed to a “Green Check” or other similarly intended indicator (dispatched).

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

1. A computer based method for minimizing loss or delayed delivery of commercially transported shipments comprising the steps of:
(a) providing a first database containing transport related data;
(b) providing a second database containing shipment article identification data;
(c) providing third software which accesses either or both databases of (a) and (b) in response to a user specified input requirement;
(d) generating at least one shipment article identification data record via a second software and storing said record within the database of (b);
(e) generating at least one transport related data record via a first software and storing said record within the database of (a);
(f) combining data records stored within the database of (a) with data records stored within the database and storing the combined records into a third database;
(g) determining a user has communicated an input requirement via the third software of (c) which requires information contained either or both databases of (a) and (b);
(h) interrogating the database of (f) in response to the user input requirement of (g); and
(i) formatting interrogated information of either or both databases of (a) and (b) responding to the user input requirement of (e) and communicating said formatted information to said user.

2. The method of claim 1 wherein either or both of the databases of (a) and (b) are interrogated in response to the user input requirement of (g).

3. The method of claim 1 wherein the user input requirement of (c) is communicated to the first software of (c) via a mutually accessible web site having user input requirement navigation tools.

4. The method of claim 1 wherein the user input requirement of (c) is communicated to the first software of (c) via a mutually accessible web site having user location specific Hot Bag information.

5. The method of claim 1 wherein the user input requirement of (c) is communicated to the first software of (c) via an accessible web site inquiry having user input requirement navigation tools and location specific Hot Bag information.

6. The method of claim 1 wherein the transport related data of (a) is commercial airline flight related data selected from a group of data including:
Date, Origin City, Flight, Origin Date, Actual Departure City, Actual Arrival City, Leg Status, Departure Status, Arrival Status, Scheduled Departure Date, Scheduled Departure Time, Scheduled Arrival Date, Scheduled Arrival Time, Actual Departure Date, Actual Departure Time, Actual Arrival Date, Actual Arrival Time, Airline, Scheduled Equipment Type, Actual Equipment Type, First Class Seats, Actual Tail (Ship) Number, Business Class Seats, Coach Class Seats, Total Seats, Ground Objective, Taxi Out Time, Taxi In Time, Departure Gate, Arrival Gate, Zone, Sub Zone, Passenger Services CSM Employee Number, Passenger Services Manager Employee Number, Ramp Services CSM Employee Number, Ramp Services Manager Employee Number, Tower CSM Employee Number, Tower Manager Employee Number, 4th Department CSM Employee Number, 4th Department Manager Employee Number, 5th Department CSM Employee Number, 5th Department Manager Employee Number, 6th Department CSM Employee Number, 6th Department Manager Employee Number, Departure Terminal, Arrival Terminal, Baggage claim Number, AM/PM Indicator, Delay Minutes, Complex Number, Scheduled First Arrival City, Scheduled Second Arrival City (“next stop” after 1st arrival city), Scheduled Third Arrival City (“next stop” after 2nd arrival city), Next Flight Number (turning flight number), Next Flight Date (turning flight date), Previous Flight Number (turned flight number), Previous Flight Date (turned flight date), Greenwich Mean Time (GMT) Adjustment For Departure City, Greenwich Mean Time (GMT) Adjustment For Arrival City, Total Customers, Thru Customers, Connecting Customers, First Class Local Count, First Class Child Count, First Class Excess Weight, First Class Thru Count, First Class Thru Child Count, First Class Thru Excess Weight, Business Class Local Count, Business Class Child Count, Business Class Excess Weight, Business Class Thru Count, Business Class Thru Child Count, Business Class Thru Excess Weight, Coach Class Local Count, Coach Class Child Count, Coach Class Excess Weight, Coach Class Thru Count, Coach Class Thru Child Count, Coach Class Thru Excess Weight, Local Cockpit Jumpseat Rider Count, Thru Cockpit Jumpseat Rider Count, Local Cabin Jumpseat Rider Count, Thru Cabin Jumpseat Rider Count, Kickoff Flight Indicator, and Time Record Last Updated.

7. The method of claim 1 wherein the shipment related data of (b) is automated baggage scan data selected formatted, into an IATA standard.

8. The method of claim 1 wherein the software of accessing either or both databases of (a) and (b) is web site compatible software and communicates with at least one user via a web site and a computer compatible communications network.

9. The method of claim 1 wherein the software of (d) is software executed in cooperation with contemporary art automated baggage scanning systems.

10. The method of claim 1 wherein the software of (e) is software executed in cooperation with commercial airline flight operation systems.

11. The method of claim 1 wherein determining a user has communicated an input requirement in (g) further comprises:
(a) accessing a web site mutually accessible to the user and software of 1(c);
(b) determining the user has specified an input requirement for information relating to Missed Bags;
(c) interrogating the provided database of claim 1(f) and identifying information necessary to respond to the inquiry of (b);
(d) formatting the information identified in (c); and
(e) communicating the formatted information of (d) to the user of 1(c).

12. The method of claim 1 wherein determining a user has communicated an input requirement in (f) further comprises:
(a) accessing a web site mutually accessible to the user and software of 1(c);
(b) determining the provided user has specified an input requirement for information relating to Upline Near Missed Bags;
(c) interrogating the database of claim 1(f) and identifying information necessary to respond to the inquiry of (b);
(d) formatting the information identified in (c); and
(e) communicating the formatted information of (d) to the user of 1(c).

13. The method of claim 1 wherein determining a user has communicated an input requirement in (f) further comprises;
(a) accessing a web site mutually accessible to the user and software of (c);
(b) determining the user has specified an input requirement for information relating to Dumped Bags;
(c) interrogating the provided database of claim 1(f) and identifying information necessary to respond to the inquiry of (b);
(d) formatting the information identified in (c); and
(e) communicating the formatted information of (d) to the user of 1(c).

14. The method of claim 1 wherein determining a user has communicated an input requirement in (f) further comprises:
(a) accessing a web site mutually accessible to the user and software of 1(c);
(b) determining the user has specified an input requirement for information relating to Gate Changes;
(c) interrogating the provided database of claim 1(a) and identifying information necessary to respond to the inquiry of (b);
(d) formatting the information identified in (c); and
(e) communicating the formatted information of (d) to the user of 1(c).

15. The method of claim 1 wherein determining a user has communicated an input requirement in (f) further comprises:
(a) accessing a web site mutually accessible to the user and software of (c);
(b) determining the user has specified an input requirement for information relating to Baggage Change Orders;
(c) interrogating the provided database of claim 1(a) and identifying information necessary to respond to the inquiry of (b);
(d) formatting the information identified in (c); and
(e) communicating the formatted information of (d) to the user of 1(c).
